(19) United States
(12) Patent Application Publication
(10) Pub. No.: US 2016/0379466 A1
(43) Pub. Date: Dec. 29, 2016

(54) System For Warning A Driver That A Passenger Is Left In A Vehicle

(71) Applicant: Continental Automotive Systems, Inc., Auburn Hills, MI (US)

(72) Inventors: Andre Payant, Rochester Hills, MI (US); Ibro Muharemovic, Shelby Township, MI (US)

(21) Appl. No.: 14/751,263

(22) Filed: Jun. 26, 2015

(51) Int. Cl. G08B 21/22; H04N 7/18; B60N 2/00

(52) U.S. Cl. CPC G08B 21/22; B60N 2/002; H04N 7/183

(57) ABSTRACT

A warning system is provided for a vehicle. The vehicle has an interior defining a driver seat area including a driver's seat, and a passenger area, behind the driver seat area, including at least one rear passenger seat. The system includes a control unit. A passenger detection sensor is associated with the control unit and is constructed and arranged to detect a presence of a passenger in the at least one rear passenger seat. A driver status sensor, associated with the control unit, is constructed and arranged to indicate a driver's positional relationship with respect to the vehicle. A warning device is associated with the control unit such that when the passenger detection sensor indicates that a passenger is in the at least one rear passenger seat and the driver status sensor indicates that the driver has left the vehicle, the control unit activates the warning device.

### FIELD

The invention relates to a system that warns a driver that a passenger remains in a rear seat of the vehicle.

### BACKGROUND

Every year, an average of thirty-eight children die of heatstroke from being left in a vehicle, about half of which deaths are due to a caregiver forgetting about the child in the vehicle. Even though the number of children dying every year is relatively low, it is nevertheless a traumatic experience for the family.

Thus, there is a need for a driver warning system that would help prevent such deaths with little to no additional cost to the automotive OEM, since the hardware components are already present in most production vehicles.

### SUMMARY

An objective of the invention is to fulfill the need referred to above. In accordance with the principles of an embodiment, this objective is obtained by providing a warning system for a vehicle. The vehicle has an interior defining a driver seat area including a driver's seat, and a passenger area, behind the driver seat area, including at least one rear passenger seat. The system includes a control unit. At least one passenger detection sensor is associated with the control unit and is constructed and arranged to detect a presence of a passenger in at least one rear passenger seat. A driver status sensor, associated with the control unit, is constructed and arranged to indicate a driver's positional relationship with respect to the vehicle. A warning device is associated with the control unit such that when the passenger detection sensor indicates that a passenger is in at least one rear passenger seat and the driver status sensor indicates that the driver has left the vehicle, the control unit is constructed and arranged to activate the warning device.

In accordance with another aspect of an embodiment, a warning system is provided for a vehicle. The vehicle has an interior defining a driver seat area including a driver's seat, and a passenger area, behind the driver seat area, including at least one rear passenger seat. The system includes a control unit. A camera is constructed and arranged to obtain images of a passenger in the passenger area. A display is provided in the driver seat area and is associated with the control unit such that the control unit can control the display to show the images to the driver so that the driver can monitor the passenger without turning his or her eyes toward the passenger seat area in order to view the passenger.

In accordance with yet another aspect of an embodiment, a method warns a driver of a vehicle that a passenger is in a rear passenger seat of the vehicle. The method determines if the vehicle is stopped. If the vehicle is stopped, a driver status sensor determines whether the driver has left the vehicle. If the driver has left the vehicle, a passenger detection sensor determines if a passenger remains behind in the vehicle. If the passenger is determined to remain behind in the vehicle, a control unit activates a warning signal.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is an interior view of a vehicle having a driver warning system including a camera and displays in accordance with an embodiment.

FIG. 2 is a schematic view of the driver warning system of an embodiment.

FIG. 3 is a flowchart of an algorithm performed by driver warning system of FIG. 2, in accordance with an embodiment.

### DETAILED DESCRIPTION OF EXEMPLARY EMBODIMENTS

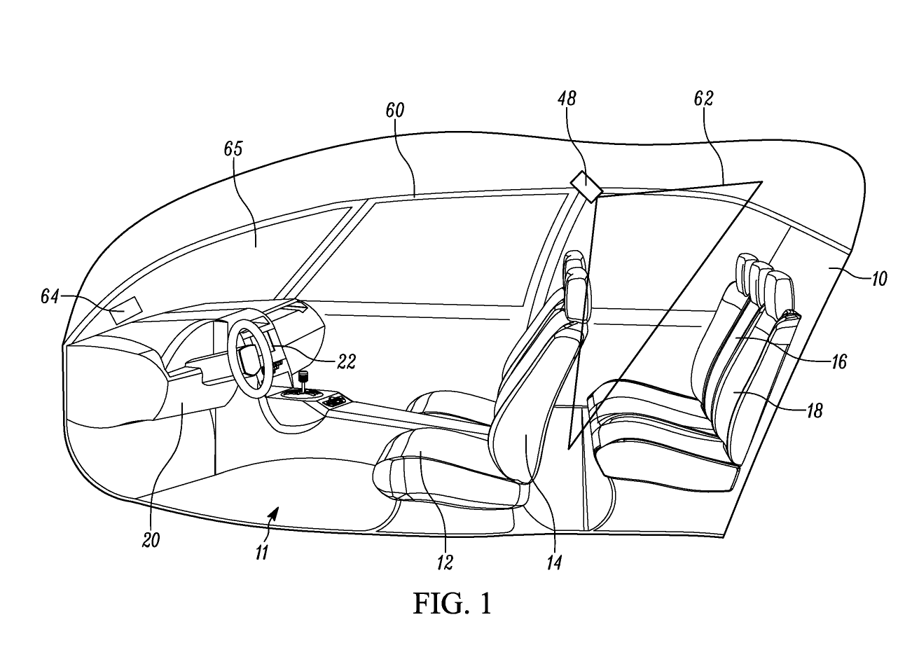

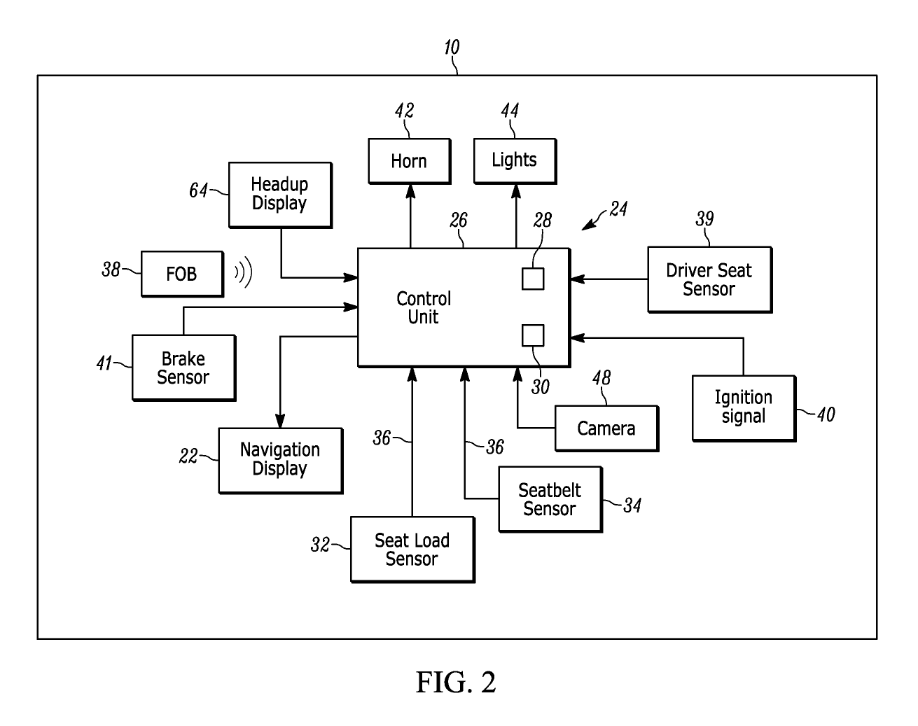

With reference to FIG. 1, an interior of a vehicle, shown generally indicated at 10. The vehicle 10 has an interior, generally indicated at 11, defining a driver seat area 12, having at least a driver's seat 14, and a passenger seat area 16, behind the driver seat area 12. The passenger area 16 has at least one rear passenger seat 18. A conventional dashboard 20 is provided in the driver seat area 12 and can include a conventional navigation system having a display 22, the function of which will be explained below. With reference to FIG. 2, a driver warning system is shown, generally indicated at 24, employed in the vehicle 10. The system 24 of the embodiment includes a control unit 26 having a processor circuit 28 and memory 30. The control unit 26 can be located anywhere in the vehicle 10. At least one passenger detection sensor is provided to detect the presence of a passenger in a rear passenger seat 18. In the embodiment, the passenger detection sensor can include a seat load sensor 32 that detects a change in weight on the rear passenger seat 18 from that of the rear passenger seat 18 absent an occupant; and/or or a seatbelt sensor 34 that detects whether the seatbelt of a rear passenger seat 18 is engaged (indicating a passenger is present); and/or a camera 48 for obtaining images or for detecting heat or motion of the passenger in the rear passenger seat 18. The camera is preferably capable of sensing one or more light spectrum ranges, including visible and infrared light. In addition or alternatively, the facial recognition software can be processed by the control unit 26 based on gaze detection, eye recognition, etc., obtained by the camera 48, to determine or confirm that there is a person left behind in the rear passenger seat 18. Signals 36 from the sensors 32 and 34 are received by the control unit 26. The passenger detection sensor is thus constructed and arranged to detect the presence of a passenger in the rear passenger seat 18 even if the passenger is a child in a car seat or booster seat placed on the passenger seat 18.

When it is determined that a passenger is in the passenger seat 18 and once a driver stops and leaves the vehicle 10, a warning is initiated. An ignition signal 40 can be received by the control unit 26 indicating that the vehicle is off. A driver status sensor obtains a signal regarding a positional relationship of the driver with respect to the vehicle 10 and sends this signal to the control unit 26 to initiate the warning. The driver status sensor can be, but is not limited to, a smart key fob 38 that transmits a signal to the control unit 26 in the conventional wireless manner. For example, the smart fob 38 can be monitored by the control unit 26 for proximity with respect to the vehicle 10 (indicating that the driver is walking away from the vehicle), or the fob 38 can be monitored by the control unit 26 to determine if the fob 38 was used to lock the doors of the vehicle 10. Alternatively, the driver status sensor can be a driver's seat weight sensor 39 that sends a signal to the control unit 26 indicating that the driver has left the driver's seat. The warning can consist of individual or combinations of signals from a warning device, such as activating the horn 42 of the vehicle 10, and/or flashing the vehicle lights 44. This warning should be sufficient to provide notice to the driver to return to the vehicle since a passenger remains in the rear passenger seat of the vehicle 10.

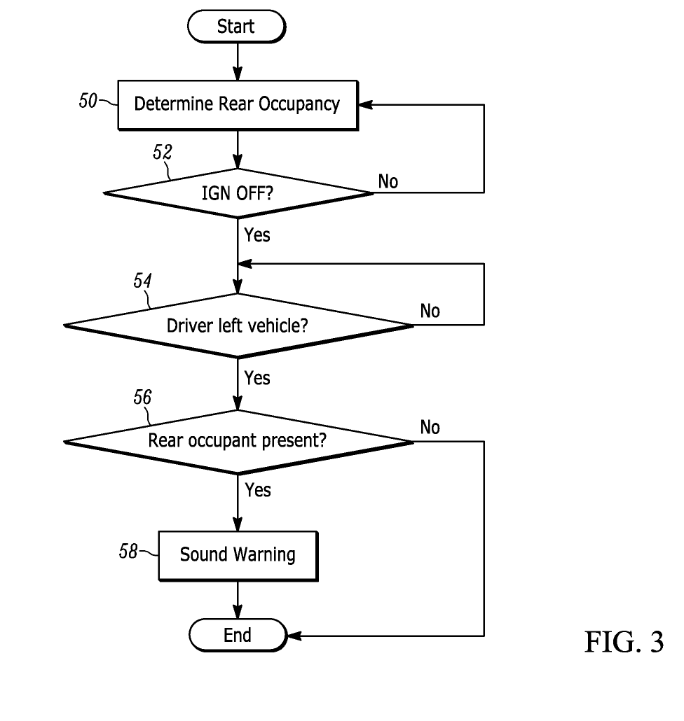

With reference to FIG. 3, an embodiment of the steps or algorithm is shown for warning the driver that a passenger remains in a rear passenger seat 18 of the vehicle, using the system 24 described above. In step 56, the passenger detection sensor 32, 34, or 48 determines if a passenger is in the rear seat area 16 (e.g., in a rear passenger seat 18) of the vehicle. If so, in step 52, it is determined if the vehicle is stopped (e.g., ignition is off). If so, in step 54, it is determined whether the driver has left the vehicle by monitoring the fob 38 or sensor 39, as noted above. If the driver has left the vehicle, in step 56, it is determined by the passenger sensor if the rear occupant or passenger remains behind in the vehicle. If so, in step 58, the control using 26 activates the warning signal such as controlling the horn 42 and/or lights 44.

Instead of warning the driver of a passenger only when the driver leaves the vehicle 10, the system 24 can monitor the passenger in the rear passenger seat 18 while the driver remains in the vehicle while operating the vehicle. Thus, the system 24 includes the interior camera 48 that is preferably mounted to headliner 60 facing the back seat area 16 to automatically detect the presence of passengers in the rear passenger seat(s) 18. The camera 48 can be wired or wireless and can communicate with the control unit 26 or can communicate directly with a display, such as the navigation system display 22. In the latter case, the navigation system can be considered to be the control unit 26 or an intermediary unit providing the camera status to the control unit 26. As shown in FIG. 1, the camera 48 preferably has a field of view 62 sufficient to detect passengers in the entire back seat area 16. The camera 48 is constructed and arranged to detect a gaze of the rear seat passenger to determine the state of the occupant to be for example sleeping, looking to the left, looking to the right, yawning, etc. The constant status of the rear passenger seat occupant(s) to the driver can be provided from the camera 48 as a message on a conventional head-up display 64 (HUD) associated with the windshield 65 or any other indicator which would not require the driver to turn around to view the passenger. Alternatively or in addition, the camera 48 can provide a live feed image of the rear seat occupant(s) to the driver as displayed on the display 22 of the conventional navigation system when the vehicle 10 comes to a standstill, such as while at a red light, for example. In this situation, the control unit 26 can, for example, receive a signal from a brake sensor 41 indicating that the vehicle brakes are depressed or can receive a signal that the vehicle is in park. Thereafter, the control unit 26 can control the display 22 to show the images. The use of the camera 48 avoids distracted driving by parents who are driving, since the driver can monitor the passenger without having to turn their attention to their newborns or toddler seated in the child seat behind them.

This constant status of the passenger reminds the driver of the presence of the passenger so that the driver will be less likely to leave the passenger behind once the driver leaves the vehicle 10. In the event the driver happens to leave the vehicle without the passenger, the warning signal(s) noted above can be initiated based on the camera 48 detecting the presence of the passenger in the rear passenger seat 18 and based on the driver status sensor as discussed above.

The operations and algorithms described herein can be implemented as executable code within the control unit 26 having processor circuit 28 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit can be implemented, for example, using a non-volatile memory such as a programmable read only memory (PROM) or an EPROM, and/or a volatile memory such as a DRAM, etc.

The warning system 24 advantageously uses many components that are already conventionally supplied in most vehicles and thus is cost effective.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A warning system for a vehicle, the vehicle having an interior defining a driver seat area including a driver's seat, and a passenger area, behind the driver seat area, including at least one rear passenger seat, the system comprising:
a control unit,
at least one passenger detection sensor, associated with the control unit, constructed and arranged to detect a presence of a passenger in the at least one rear passenger seat,
a driver status sensor, associated with the control unit, constructed and arranged to indicate a driver's positional relationship with respect to the vehicle, and
a warning device associated with the control unit,
wherein when the passenger detection sensor indicates that a passenger is in the at least one rear passenger seat and the driver status sensor indicates that the driver has left the vehicle, the control unit is constructed and arranged to activate the warning device,
wherein the driver status sensor comprises a driver's seat weight sensor constructed and arranged to indicate that the driver has left the driver's seat.

2. The system of claim 1, wherein the passenger detection sensor comprises a seat load sensor constructed and arranged to detect a change in weight on the at least one rear passenger seat from that of a rear passenger seat absent an occupant thereon.

3. The system of claim 1, wherein the passenger detection sensor comprises a seatbelt sensor constructed and arranged to detect whether a seatbelt, associated with the at least one rear passenger seat, is engaged.

4. The system of claim 1, wherein the passenger detection sensor comprises a camera, capable of sensing one or more light spectrum ranges, including visible and infrared light.

5. A warning system for a vehicle, the vehicle having an interior defining a driver seat area including a driver's seat, and a passenger area, behind the driver seat area, including at least one rear passenger seat, the system comprising:
a control unit,
at least one passenger detection sensor, associated with the control unit, constructed and arranged to detect a presence of a passenger in the at least one rear passenger seat,
a driver status sensor, associated with the control unit, constructed and arranged to indicate a driver's positional relationship with respect to the vehicle, and
a warning device associated with the control unit,
wherein when the passenger detection sensor indicates that a passenger is in the at least one rear passenger seat and the driver status sensor indicates that the driver has left the vehicle, the control unit is constructed and arranged to activate the warning device,
wherein the driver status sensor comprises a smart fob in communication with the control unit and constructed and arranged to indicate that the driver is walking away from the vehicle or to indicate that the fob has locked the doors of the vehicle.

6. (canceled)

7. The system of claim 1, wherein the warning device comprises a horn of the vehicle, with the control unit being constructed and arranged to activate the horn, and/or the warning device comprises lights of the vehicle, with the control unit being constructed and arranged to activate the lights.

8. The system of claim 4, wherein the camera is constructed and arranged to obtain images of a passenger in the at least one passenger seat, the vehicle including a display, the control unit being constructed and arranged to control the display to show the images to the driver so that the driver need not turn around to see the passenger.

9. The system of claim 8, wherein the display is a display of a navigation system of the vehicle.

10. The system of claim 8, wherein the display is a head-up display associated with a windshield of the vehicle.

11. A warning system for a vehicle, the vehicle having an interior defining a driver seat area including a driver's seat, and a passenger area, behind the driver seat area, including at least one rear passenger seat, the system comprising:
a control unit,
a camera, constructed and arranged to obtain images of a passenger in the passenger area, and a display in the driver seat area and associated with the control unit such that the control unit can control the display to show the images to the driver so that the driver can monitor the passenger without turning his or her eyes toward the passenger seat area in order to view the passenger,
wherein the control unit is constructed and arranged to control displaying live images of the passenger on the display of the navigation system only when the vehicle is a standstill.

12. The system of claim 11, wherein the display is a display of a navigation system of the vehicle.

13. (canceled)

14. The system of claim 11, wherein the display is a head-up display associated with a windshield of the vehicle.

15. The system of claim 11, wherein the camera is constructed and arranged to detect a gaze of a passenger in the at least one rear passenger seat.

16. The system of claim 11, further comprising:
a driver status sensor, associated with the control unit, indicating a driver's positional relationship with respect to the vehicle, and
a warning device associated with the control unit,
wherein when the camera indicates that a passenger is in the at least one rear passenger and the driver status sensor indicates that the driver has left the vehicle, the control unit is constructed and arranged to activate the warning device.

17. The system of claim 16, wherein the driver status sensor comprises a smart fob constructed and arranged to indicate that the driver is walking away from the vehicle or to indicate that the fob has locked the doors of the vehicle.

18. A method of warning a driver of a vehicle that a passenger is in a rear passenger seat of the vehicle, the method comprising:
determining if the vehicle is stopped,
if the vehicle is stopped, determining, by a driver status sensor, whether the driver has left the vehicle,
if the driver has left the vehicle, determining, by a passenger detection sensor, if a passenger remains behind in the vehicle, and
if the passenger is determined to remain behind in the vehicle, activating, by a control unit, a warning signal,
wherein the passenger detection sensor comprises:
a seat load sensor and the step of determining if a passenger remains behind comprises detecting, using the seat load sensor, a change in weight on the rear passenger seat from that of an empty rear passenger seat; or
a seatbelt sensor and the step of determining if a passenger remains behind comprises detecting, using the seatbelt sensor whether a seatbelt associated with the rear passenger seat is engaged; or
a camera and the step of determining if a passenger remains behind comprises detecting movement or heat of the passenger by the camera.

19. (canceled)

20. The method of claim 18, wherein the driver status sensor comprises a smart fob in communication with a control unit of the vehicle, and the step of determining whether the driver has left the vehicle comprises:
monitoring a proximity of the smart fob with respect to the vehicle, or
monitoring if the smart fob was used to lock the doors of the vehicle.
